(19) United States
(12) Patent Application Publication
(10) Pub. No.: US 2009/0296674 A1
(43) Pub. Date: Dec. 3, 2009

(54) METHOD AND APPARATUS FOR DENSITY DETERMINATIOIN IN A WIRELESS COMMUNICATION NETWORK

(75) Inventors: Randy L. Ekl, Lake Zurich, IL (US); Mark A. Birchler, Lake Zurich, IL (US); Isam R. Makhlouf, Lake Zurich, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC, Schaumburg, IL (US)

(21) Appl. No.: 12/129,647

(22) Filed: May 29, 2008

(51) Int. Cl. H04Q 7/24

(52) U.S. Cl. 370/338

(57) ABSTRACT

Each node in a wireless communication network adds information in hello messages wherein the information comprises the number of hello messages received at the node from a plurality of nodes. Also, the nodes are configured to determine the node density based on additional information extracted from the received hello messages. For example, a first node in the wireless communication network receives a hello message from a second node, wherein the hello message comprises additional information indicating at least a number of hello messages received by the second node from a plurality of nodes in the wireless communication network. The first node extracts the additional information from the received hello message and based on the extracted additional information, the first node determines at least one channel performance metric. Based on the at least one channel performance metric the first node determines density of neighboring nodes in the wireless communication network.

### FIELD OF THE DISCLOSURE

The present disclosure relates generally to wireless communications and more particularly to a method and apparatus for density determination in a wireless communication network.

### BACKGROUND

In some wireless communication systems a communication device establishes a link with at least one access point to communicate with another mobile/fixed-line communication device. Generally, every wireless communication network includes communication mechanisms necessary to ensure reliable transmission of information between any two or more wireless communication devices. An Ad-hoc network is one example of such a wireless communication network. An Ad-hoc network is a self-configuring and self-healing localized wireless network that is used to enable communication among a plurality of mobile devices. An ad-hoc network comprises a group of nodes (or terminals), each with a wireless adapter, capable of operating on a peer-to-peer basis, communicating directly with each other without the use of an access point or other fixed infrastructure device.

In an Ad-hoc network, message transmission and exchange of control information between several nodes can be implemented more efficiently when the local node density is determined at each node. Based on the local density of nodes, a plurality of parameters such as routing path and optimum power level for message transmission, can be determined at each node. Generally, each node in the Ad-hoc network transmits messages based on the plurality of parameters estimated from the local density of nodes in the Ad-hoc network.

One conventional technique for determining local density of nodes in an Ad-hoc network utilizes Global Positioning System (GPS) technology. However, GPS-based solutions may not perform well indoors, and not all Ad-hoc nodes may be GPS capable. Thus, GPS based techniques are not a reliable solution for accurately determining local density of nodes in the Ad-hoc network. Another approach is to use ranging techniques in which the ranges of local nodes are estimated based on transmitted and received signal strengths from the nodes. Node density is then estimated by determining the number of nodes within a given area. However, due to environmental factors there is non-linear relationship between the range and the received signal strength. Thus, without some means to characterize and take into account the environmental factors, the ranging technique is generally not accurate. Consequently, the parameters associated with channel performance which are determined based on the local density of nodes may be inaccurate. For example, if a node fails to accurately determine local density of nodes using ranging techniques, the node is unable to determine the optimum power level for message transmission. Usage of excessive power in transmitting messages effects battery life of communication devices associated with the Ad-hoc nodes and contributes more interference to the system.

Accordingly, there is a need for a method and apparatus to determine density of nodes for efficient message transmission between a plurality of nodes in a wireless communication network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a wireless communication network, wherein embodiments of the invention can be implemented.

FIG. 2 is a flow diagram of a method to determine density of nodes in a wireless communication network in accordance with some embodiments.

FIG. 3 is a flow diagram of a method to determine density of nodes in a wireless communication network in accordance with alternate embodiments.

FIG. 4 illustrates a statistical table comprising communication parameters for a plurality of nodes in accordance with some embodiments.

FIG. 5 is a signaling diagram illustrating a method for determining density of nodes at a node in accordance with some embodiments.

FIG. 6 is a signaling diagram illustrating a method for determining density of nodes at a node in accordance with some embodiments.

FIG. 7 is a block diagram illustrating an apparatus to determine density of nodes in a wireless communication network in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments, a node determines local density of nodes (hereafter “node density”) in a wireless communication network to accurately determine communication parameters associated with a plurality of nodes for efficient message transmission. Every node in the wireless communication network adds information in the hello message including the number of hello messages received at the node from a plurality of nodes. Also, every node is configured to determine the node density based on additional information extracted from the received hello messages. For example, a first node in the wireless communication network receives a hello message from a second node, wherein the hello message comprises additional information indicating at least a number of hello messages received by the second node from a plurality of nodes in the wireless communication network. The first node extracts the additional information from the received hello message and based on the extracted additional information, the first node determines at least one channel performance metric. The first node determines density of neighboring nodes in the wireless communication network based on the at least one channel performance metric.

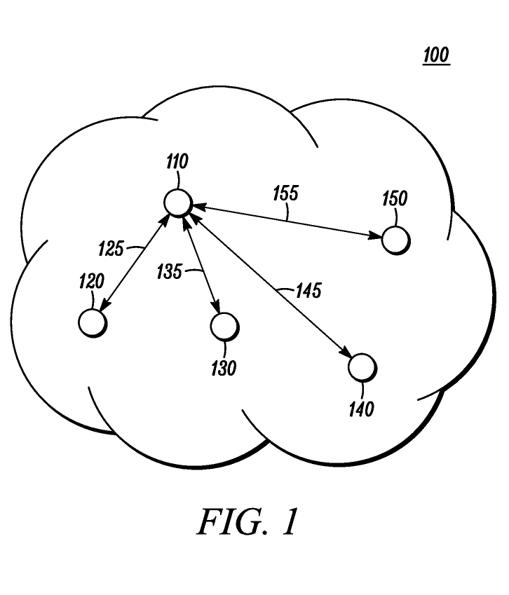

Referring now to drawings, and in particular FIG. 1, a wireless communication network is shown and indicated at 100. In accordance with some embodiments, nodes in the wireless communication network 100 implement a method to determine local density of nodes in the wireless communication network 100. Those skilled in the art will recognize and appreciate that the specifics of this example are merely illustrative of various embodiments and that the teachings set forth herein are applicable in a variety of alternative settings. For example, in some embodiments, the nodes in the wireless communication network 100 operate in accordance with standards promulgated by Institute of Electrical and Electronics Engineers (IEEE) and Internet Engineering Task Force (IETF), such as IEEE standards 802.11. (For this and any IEEE standards recited herein, see: http://standards.ieee.org/getieee802/index.html or contact the IEEE at IEEE, 445 Hoes Lane, PO Box 1331, Piscataway, N.J. 08855-1331, USA.) It will be appreciated by those of ordinary skill in the art that the teachings disclosed herein are not limited to any particular system implementation. As such, other alternate implementations using different communications systems operating on different protocols are contemplated and within the scope of the various teachings described herein. Generally, the teachings disclosed herein are applicable in any wireless communication system which can dynamically alter their topology and/or operational parameters to respond to the needs of a particular user while enforcing operating and regulatory policies and optimizing overall network performance. Cognitive networks are examples of such smart networks.

As shown in FIG. 1, the wireless communication network 100 comprises a plurality of nodes 110, 120, 130, 140, 150. Although, FIG. 1 shows five nodes 110, 120, 130, 140, 150, those skilled in the art will realize and appreciate that the embodiments of the invention can be implemented in any wireless communication network comprising any quantity of nodes. As used herein, the term node includes, but is not limited to, equipment/apparatus commonly referred to as access devices, access terminals, user equipment, mobile stations, mobile devices, and any device capable of operating in a wireless environment. Each of the nodes 110, 120, 130, 140, 150 has at least a transceiver, a processing device, an amplifier, a memory unit, and an interface for communications with other nodes in the wireless communication network 100.

As shown in FIG. 1, the plurality of nodes 110, 120, 130, 140, 150 communicate with each other or with other mobile/fixed-line communication devices (not shown) by sending messages via a wireless interface comprising wireless links. For example, a first node 110 communicates with a second node 120 by establishing and using a wireless link 125. Similarly the first node 110 can communicate with other nodes 130, 140 and 150 by establishing and using wireless links 135, 145, and 155 respectively. A node can establish and communicate over the wireless links 125, 135, 145, and 155 by using any suitable wireless protocol. As shown in FIG. 1, the first node 110 operationally can communicate directly with all other nodes 120, 130, 140, and 150. Such direct communication between nodes is an example of single hop communications. Those skilled in the art will appreciate that in certain situations (e.g. when node 120 is the first node and node 150 is the second node, the first node 120 communicates with second node 150 via intermediate node 110) the nodes can communicate using multi-hop communications. Thus, the teachings described herein are also applicable to multi-hop communications.

In accordance some embodiments of the invention, the first node 110 receives hello messages from nodes 120, 130, 140, and 150. Hello messages are messages which declare presence of a node (i.e. by receiving a hello message from the second node 120 the first node 110 can determine if the second node 120 is present adjacent and/or within the hearing range of the first node 110). Generally, every node transmits hello messages periodically after every hello-interval using any suitable protocol. Each node maintains a database to store channel performance metrics and communication parameters for every other node in the wireless communication network. Based on the information in the hello messages, the nodes update their own database. Further, in accordance with the embodiments each node operates to determine local node density in the wireless communication network 100 for efficient message transmission.

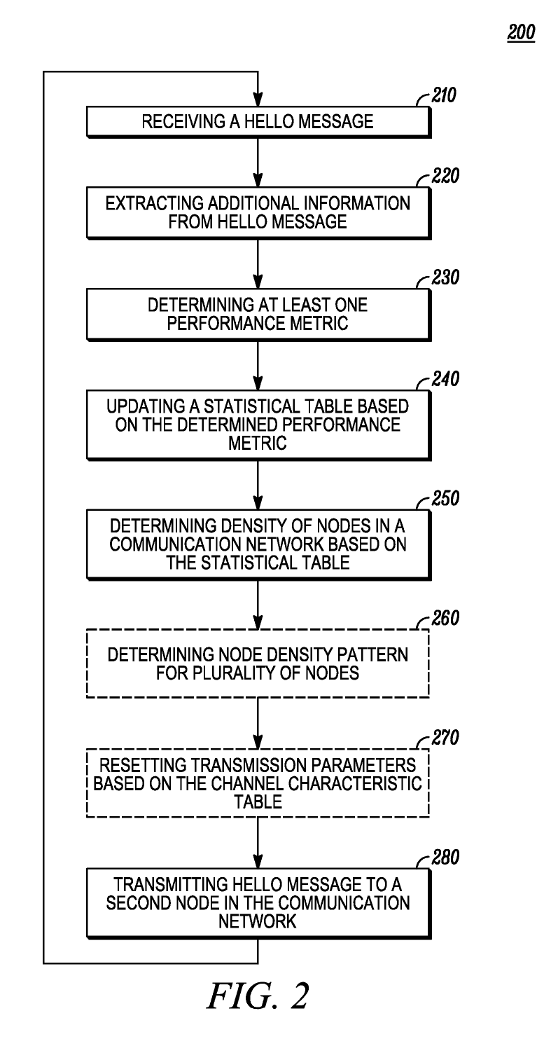

Turning now to FIG. 2, a flow diagram illustrating a method to determine density of nodes in the wireless communication network in accordance with some embodiments is shown and indicated at 200. The method 200 can be implemented at any of the nodes 110, 120, 130, 140 and 150 in the wireless communication network 100 shown in FIG. 1. It will be appreciated by those of ordinary skill in the art that the method 200 illustrated by reference to FIG. 2 includes functionality that may be performed in hardware, firmware, software or a combination thereof and may further be performed at a single node or a combination of nodes in the wireless communication network 100. Also, one or more steps of the method 200 can be performed at supporting hardware units external to the nodes.

Illustrative details for implementing the flow diagram 200 will next be described. At step 210, a first node (i.e. node 110 in FIG. 1) receives a hello message from a second node, wherein the hello message comprises additional information indicating at least a number of hello messages received by the second node from a plurality of nodes. The second node can be any one of the local nodes 120, 130, 140, 150 in the wireless communication network 100. Generally, additional information in the hello messages further comprises information indicating power level used by the second node to transmit the hello messages, frequency/hello-interval at which the second node transmits hello messages, and the modulation scheme used by the second node to transmit hello messages. In one embodiment, the additional information comprises a quantity of hello messages received in a time period at the second node. At step 220, the first node extracts the additional information from the hello message.

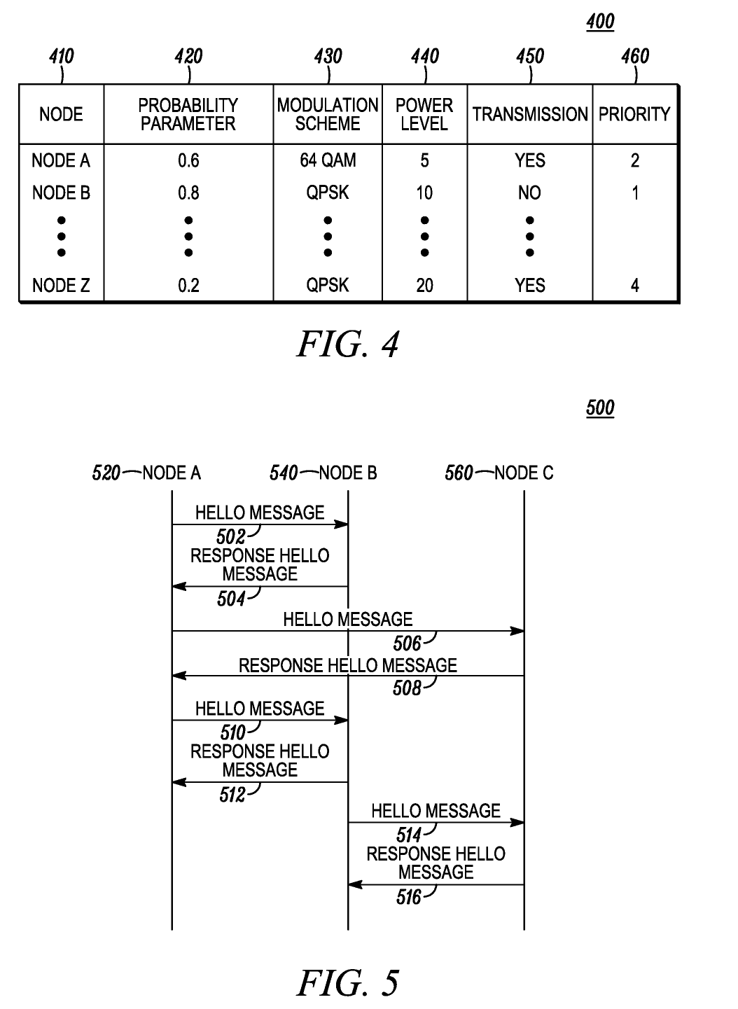

At step 230, the first node determines at least one channel performance metric based on the additional information extracted from the hello message. For example, based on the information indicating number of hello messages received by the second node, the first node determines channel performance metric such as probability parameter associated with the probability of reception of messages from the first node at the second node. Generally, determining at least one channel performance metric comprises forming a statistical table for a plurality of nodes. In one embodiment, the statistical table comprises communication parameters of one or more received signals received from the at least one of the plurality of nodes. FIG. 4 illustrates an exemplary statistical table 400 in accordance with some embodiments (described in detail later). At step 240, the first node updates the statistical table based on the determined channel performance metric. Since Ad-hoc networks are dynamic in nature, due to the relative motion of nodes and/or change in environmental factors, the ability of a node to communicate with another node (transmit/receive messages) varies with time. In accordance with the embodiments of the invention, each node updates the statistical table based on the additional information extracted from the hello message. Since every node transmits hello messages periodically, the updating of the statistical table at each node is a continuous process, which helps the node to maintain the most recent communication parameters. Updating of the statistical table at each node comprises updating values in fields corresponding to a plurality of communication parameters associated with a plurality of nodes and creating new fields for the communication parameters of nodes which do not previously have entries in the statistical table.

At step 250, the first node determines the density of nodes in the wireless communication network based on at least one channel performance metric. Generally, since the channel performance metric (such as a probability parameter) is stored in the statistical table, the first node pulls data from the statistical table to determine the density of nodes. If every node in the wireless communication network knows the power level at which it is transmitting the hello messages, every node is capable of estimating the density of nodes within an area based on the power of the received hello messages and the information in the hello messages from other nodes which indicate the number of received hello messages. Generally, the density of nodes is determined at the first node by dividing the number of nodes which can be heard from the first node by the radio coverage area of the first node.

The following example illustrates the step of determining density of nodes at the first node in accordance with some embodiments. The range/distance between the reference device (the device that is estimating the density of devices in its local vicinity, i.e. first node) and observed device (second node) using a given modulation and coding scheme can be estimated using the following equation:

Rₘ=d₀*10̂[(Pᵢ−P₀)/(10n(Env))]

### Where:

Rₘ=the mean estimated range between the reference device and the observed device,
d₀=the reference distance from the transmitting antenna (generally one (1) meter)
Pᵢ=the inferred path loss for the received transmission from the observed device,
P₀=the reference path loss at the reference distance (d0, known), and
n(Env)=the path loss exponent (a function of the environment type).

Generally, the term Pᵢ is a composite value that is calculated either based on information obtained from the transmitting device or information known or inferred about the received gain/loss lineup. The equation for Pᵢ and the source for the information required to calculate its value follows:

Pᵢ=P_{EIRP}−Pₘ+G_{A,RX}−G_{C,RX}−G_{HB}+B_{LN}*σ(Env)

### Where:

P_{EIRP}=the Effective Isotropic Radiated Power of the transmitting device,
Pₘ=the observed power of the signal received from the transmitting device as measured in the receiver,
G_{A,RX}=the Receiver Antenna Gain,
G_{C,RX}=receiver cable losses,
G_{HB}=the Head/Body Loss (can be a mean number),
B_{LN}=a lognormal fading/shadowing bias term, and
σ(Env)=the estimated lognormal fading/shadowing standard deviation (a function of the environment type).

For most of the wireless communication channels, the measured power, Pₘ, will vary due to fast and lognormal fading. Fast fading variation can be reduced via averaging the signal power over the equivalent of tens (10s) to hundreds (100s) of wavelengths, which is practical in most cases (therefore, it is assumed that this factor has been “averaged out” in the above equation). Note that the additional lognormal fading path loss is due to shadowing processes that occur over the distance of 100's of wavelengths. Thus this component cannot be averaged out unless the signal power averaging distance between the reference and observed devices is on the order of 1000's of wavelengths, which is rarely practical. The standard deviation of the lognormal fading can be inferred based on the estimated environment type. This provides a confidence interval about the mean observed path loss, and hence about the mean estimated ranges between devices.

The environment type can be estimated by using the following technique. The environment type, Env, (e.g., indoor, typical urban, suburban, rural, etc.) that the reference device is operating in must be inferred from additional information that is collected and entered into an algorithm which makes a “best estimate” based on the available data. For example, if the calendar application shows that the device owner is scheduled to be in a meeting or at work and the ambient sounds are consistent with those of an office or business meeting then the estimate of an indoor enterprise environment is likely correct. On the other hand, if the ambient sound information is consistent with that of an urban downtown area, then a typical urban environment may be the best estimate. The application of additional data and intelligence can be easily seen to enhance the reliability of the environmental type estimate.

Once Env has been estimated, n and σ can be determined by a simple lookup table as exemplified in Table 1 shown below. Note that the Environment designations are referring to technical models that relate to the more user-friendly designations such as “suburban” and “indoor” used above.

TABLE 1

| | | Shadowing |
|---|---|---|
| | | Std. Dev. σ |
| Environment (Env) | n | (dB) |
| A-LOS-1F-Iso | 2.2 | 6 |
| A-NLOS-1F-Iso | 3.6 | 5 |
| Ab-LOS-1F-Iso | 3.2 | 6 |
| Ab-NLOS-1F-Iso | 4.6 | 5 |
| Ab-NLOS-1F-Dense | 3 | 3 |
| Ab-NLOS-MF-Iso | 6.5 | 6 |
| Ab-NLOS-MF-Dense | 3.7 | 4 |
| C-LOS-1F-Iso | 2.05 | 7 |
| C-NLOS-1F-Iso | 3.3 | 6 |

Typically, B_{LN} in Equation (2) is a bias term that is used to factor the lognormal fading statistics into the inferred path loss calculation. When this term is positive, larger range estimates result, and hence lower node density estimates. Conversely, when the term is negative, smaller range and higher node density estimates result. Table 2 below illustrates some example lognormal fading/shadowing bias term values and their corresponding statistical implications. The relationship between B_{LN} and the listed percentile values comes from the Gauss Error Function for normal distributions.

TABLE 2

| | B_{LN} | | | | |
|---|---|---|---|---|---|
| | −2 | −1 | 0 | +1 | +2 |
| Percentile of the | 2.5 | 15 | 50 | 85 | 97.5 |
| lognornmal shadowing | | | | | |
| distribution | | | | | |

Thus, the technique through which we calculate the value of Rₘ, the estimated range between the reference device and observed device as well as the confidence interval (e.g. one standard deviation) associated with the range estimate in a given environment has been enabled. Now that we have this value for each transmitting device (say, B through Z, where A is the reference device) for which we are able to decode signals, we can construct a table such as Table 3 below:

TABLE 3

| | Rm, | Rm, |
|---|---|---|
| | B_LN = 0 | B_LN = 1 |
| Device | (meters) | (meters) |
| B | 11 | 13 |
| L | 12 | 14 |
| Y | 19 | 23 |
| X | 22 | 26 |
| K | 23 | 27 |
| O | 25 | 30 |
| D | 26 | 31 |
| F | 28 | 33 |
| J | 30 | 36 |
| Q | 38 | 44 |
| Z | 38 | 44 |
| P | 45 | 54 |
| W | 45 | 54 |
| G | 55 | 65 |
| H | 67 | 76 |
| V | 77 | 88 |
| N | 79 | 101 |
| R | 88 | 105 |
| C | 119 | 130 |
| I | 120 | 139 |
| U | 145 | 167 |
| S | 156 | 188 |
| T | 167 | 199 |
| M | 200 | 237 |
| E | 201 | 247 |

Those skilled in the art will appreciate that the lognormal fading standard deviation could be used in more sophisticated ways, for example, creating node range estimates (and thus density estimates) that have probabilistic components. Also, a probabilistic view of node density can be used in a number of ways, for example to adjust node behavior in a more continuous manner by defining a “soft” weighting technique that maps node density to behavior (e.g. routing parameter adjustment, power control, modulation and coding selection, etc.).

Referring again to FIG. 2, at step 260 the first node determines a node density pattern for a plurality of nodes in the wireless communication network 100. Typically, the communication parameters stored in the statistical table are compared with a plurality of predetermined parameters at the first node to estimate the density pattern in the wireless communication network. For example, when the first node determines that some threshold number (τ) of the local nodes are using a high level modulation (e.g., sixty four Quadrature amplitude modulation (64 QAM)), each (τ) node is transmitting hello messages at a modest power level, and the hello messages from each of the (τ) nodes are being received with high probability, then the first node would determine a High Node Density pattern. Alternatively, when the first node determines that some threshold number (τ) of the local nodes are using a low level modulation (e.g., quadrature phase-shift keying (QPSK)), each (τ) node is transmitting hello messages at a high power level, and the hello messages from each of the (τ) nodes are being received with high probability, then the first node would determine a Low Node Density pattern. Alternatively, when the first node determines that some threshold number (τ) of the local nodes are using a low level modulation (e.g., QPSK), each (τ) node is transmitting hello messages at a high power level, and the hello messages from each of the (τ) nodes are being received with low probability, then the first node would determine an Extremely Low Node Density pattern.

Those skilled in the art will appreciate that more complex algorithms can be developed to more accurately and/or reliably determine node density. For example, rather than using a simple threshold, the Node could create multi-dimensional histograms of modulation, coding rate, power, successful decoding rate, and the like, and then transform from the histogram to an underlying node density. This transformation could be based on heuristic (e.g., computer simulations) or theoretical solutions.

At step 270 of FIG. 2, the first node adjusts the transmission parameters for message exchange based on the determined density of nodes and the information stored in the statistical table. For example, based on the communication parameters in the statistical table, the first node can adjust the power level of message transmission to transmit messages at optimum power level to increase battery life and minimize system interference. Furthermore, for multi-hop communications, the first node can determine routing paths for messages based on the density of nodes and communication parameters stored in the statistical table. In accordance with some embodiments the first node also adjusts the frequency of transmission of hello messages based on the density of nodes and the communication parameters stored in the statistical table. For example, if the communication parameters for one of the nodes change rapidly, then the first node will transmit hello messages to the node more frequently to timely gain knowledge about the most current communication parameters.

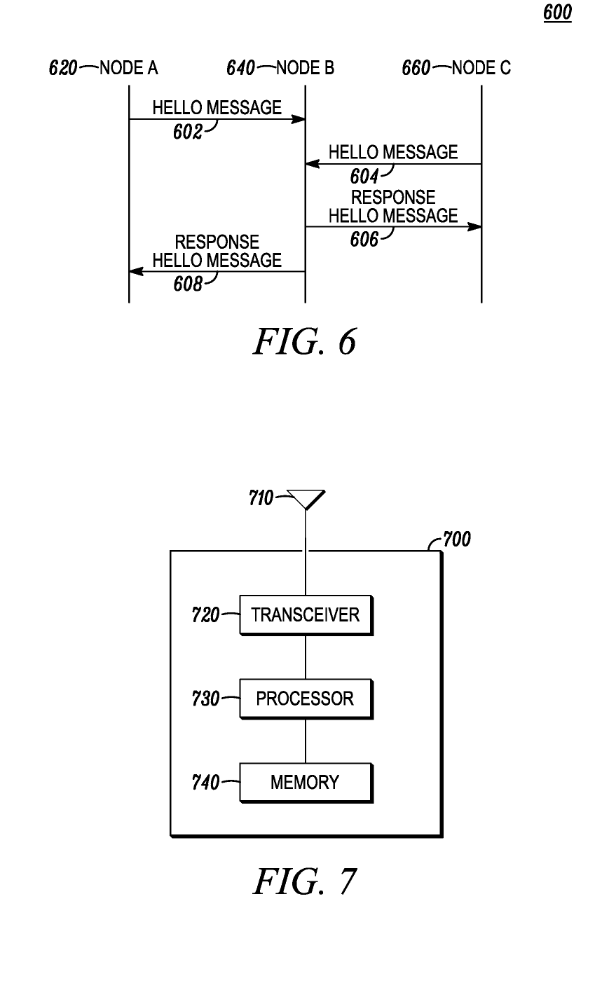

At step 280, the first node sends a response hello message to the second node in the wireless communication network. Generally, the first node adds information indicating the number of hello messages it has received over a period of time from other nodes in the hello message before transmission. In accordance with some embodiments, the first node also adds the updated communication parameters in the hello messages. Subsequently, the hello messages from the first node are received by other nodes in the wireless communication network. The other nodes receive and process the additional information in the hello messages as described in steps 210, 220, 230, 240, 250, 260, 270, and 280 shown in FIG. 2. The information added by the first node in the response hello message aids the recipient nodes in determination of local node density. In an alternate embodiment, the first node transmits the hello messages with additional information periodically to a plurality of nodes. Furthermore, the hello messages to a particular node can be prioritized based on one or more channel performance metrics. The concept of prioritizing hello messages to particular nodes will be described later in detail with reference to FIG. 6.

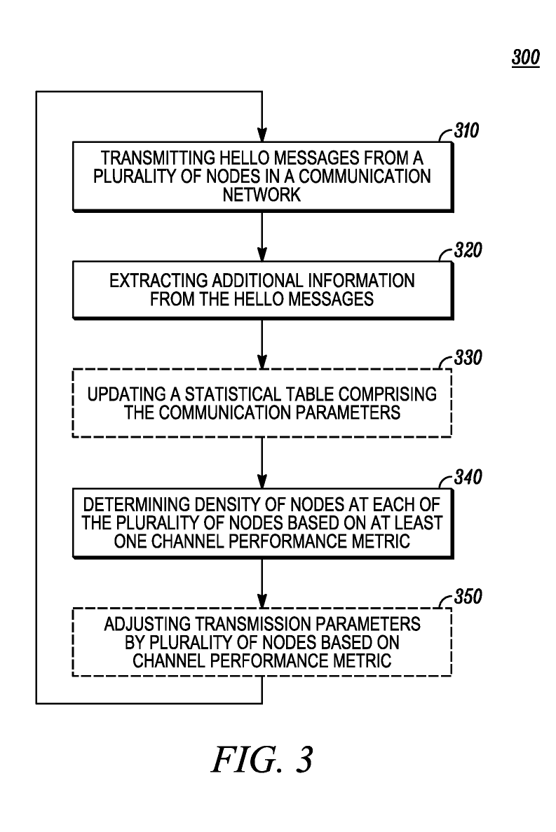

Turning now to FIG. 3, a flow diagram illustrating a method to determine density of nodes in the wireless communication network in accordance with some embodiments is shown and indicated at 300. It will be appreciated by those of ordinary skill in the art that the method 300 illustrated by reference to FIG. 3 includes functionality that may be performed in hardware, firmware, software or a combination thereof and may further be performed at a single node or a combination of nodes in the wireless communication network 100. Also, one or more steps of the method 300 can be performed at supporting hardware units external to the nodes.

Illustrative details for implementing the flow diagram 300 will next be described. At step 310, a plurality of nodes in the wireless communication network transmits hello messages, wherein each of the hello messages comprise additional information. Generally, the additional information in a hello message from a node indicates a number of hello messages received by the node from the plurality of nodes in the wireless communication network over a time period. At step 320, the additional information is extracted from the hello messages to determine at least one channel performance metric for the plurality of nodes in the wireless communication network. For example, based on the information indicating a number of hello messages received by the second node, the first node determines a channel performance metric such as a probability parameter associated with the probability of reception of messages from the first node at the second node. Generally, determining at least one channel performance metric comprises forming a statistical table, wherein the statistical table includes a plurality of entries comprising communication parameters of one or more received communication signals received from at least one of the plurality of nodes. In alternate embodiments, the statistical table is updated based at least in part on the channel performance metric at step 330. FIG. 4 illustrates an exemplary statistical table 400 in accordance with some embodiments (described in detail later). The statistical table can be considered as a database for storing communication parameters for the plurality of nodes in the wireless communication network. The plurality of communication parameters include, but are not limited to, power level used for transmitting hello messages, frequency of transmitting hello messages, modulation scheme used to transmit hello message. Typically, the above communication parameters are extracted from the incoming hello messages.

At step 340, at each of the plurality of nodes, the density of hello messages is determined based on the at least one channel performance metric. In accordance with some embodiments determining density of nodes at each of the plurality of nodes further comprises estimating proximity of nodes based on the additional information. As described above, each node in the wireless communication network is capable of determining the density of nodes locally by using the additional information in the hello messages. In accordance with some embodiments of the invention, determining the density of nodes at each of the plurality of nodes further comprises determining a probability characteristic of receiving hello messages from the plurality of nodes based on the at least on channel performance metric and counting a number of nodes, each using similar modulation scheme and each having same probability characteristic. The counted number of nodes can be compared to a predetermined threshold to determine a node density pattern at each of the node in the wireless communication network. For example, when the first node determines that some threshold number (τ) of the local nodes are using a high level modulation (e.g., 64 QAM), each of the (τ) nodes are transmitting hello messages at modest power level, and the hello messages from each of the (τ) nodes are being received with a high probability then the first node would determine a High Node Density pattern. Alternatively, when the first node determines that some threshold number (τ) of the local nodes are using a low level modulation (e.g., QPSK), each of the (τ) nodes are transmitting hello messages at a high power level, and the hello messages from each of the (τ) nodes are being received with a high probability, then the first node would determine a Low Node Density pattern. Alternatively, when the first node determines that some threshold number (τ) of the local nodes are using a low level modulation (e.g., QPSK), each of the (τ) nodes are transmitting hello messages at a high power level, and the hello messages from each of the (τ) nodes are being received with a low probability, then the first node would determine an Extremely Low Node Density pattern.

At step 350, each node adjusts transmission parameters after detecting a change in the communication parameter for at least one of the plurality of nodes. For example, based on a change in the communication parameters associated with a particular node, a node can adjust the power level of message transmission to the particular node to transmit messages at optimum power level to increase battery life and minimize system interference. Furthermore, for multi-hop communications a node can determine routing paths for messages based on the density of nodes and communication parameters stored in the statistical table.

Also, in accordance with some embodiments of the invention, a first node sends response hello messages (second hello message) to a plurality of nodes in the wireless communication network. In an alternate embodiment, the first node transmits hello messages periodically. In accordance with some embodiments, the first node implements the following round robin approach in transmitting hello messages. The first node chooses a subset of the nodes from which it has received hello messages and adds additional information indicating communication parameters associated with the communications from those nodes in its hello message. The first node marks, in an internal database (statistical table), that it has sent information about the communications with those nodes. At the end of the next time period, the first node chooses a subset of nodes which it has not yet communicated with, includes the information about the remaining nodes in the next hello message, and marks the internal database (statistical table) accordingly. The first node continues to repeat the above process at each time period (generally equal to hello-interval) until all communication parameters associated with all nodes are communicated in the hello messages. The first node then starts the process again by transmitting a new hello message to other nodes in the wireless communication network.

FIG. 4 illustrates a statistical table 400 comprising a plurality of communication parameters for a plurality of nodes in accordance with some embodiments. The statistical table of a node A′ comprises a list of nodes 410 which the node can communicate with at a given time. For example, the list of nodes 410 includes nodes A-Z which the node A can communicate with. The statistical table 400 also has entries for channel performance metrics, such as probability parameters 420 associated with each node. The probability parameters 420 associated with the nodes A-Z are the probabilities of reception of hello messages from node A at nodes A-Z. The statistical table 400 further includes entries for communication parameters associated with a plurality of nodes in the wireless communication network. For example, the statistical table includes entries for modulation scheme 430 and power level 440 used by nodes A-Z for transmitting the hello messages. Generally, the entries for probability parameters 420, modulation scheme 430 and power level 440 are populated and/or updated in the statistical table based on the additional information extracted from the hello messages. The statistical table 400 also has entries for transmission 450. The entries for transmission 450 are used in the implementation of round robin approach for transmitting hello messages. Based on the YES and NO entries for each node A-Z node A′ determines if it has already sent a hello to another node in the wireless communication network. The statistical table 400 also comprises entries for priority 460. The priority entry corresponding to each of the nodes A-Z is used in prioritizing hello messages in the wireless communication network.

Those skilled in the art will appreciate that the statistical table 400 is not limited to the entries shown in FIG. 4. As such other entries, such as number of hello messages from nodes A-Z, sequence number of each of the hello messages, and the like are contemplated and are within the scope of the various embodiments of the invention.

FIG. 5 is a signaling diagram illustrating a method for determining density of nodes at a first node in accordance with some embodiments. FIG. 5 shows three nodes: node A 520, node B 540, and node C 560. For the purpose of illustration node B 540 is considered as the first node which determines the density of nodes in accordance with some embodiments. However, those skilled in the art will appreciate that the method to determine density of nodes can be implemented at any node. As shown in FIG. 5, node A 520 transmits a hello message 502, carrying additional information to node B 540. Node B 540 extracts the additional information from the hello message and determines the density of nodes locally based on the extracted additional information in accordance with embodiments of the invention. After adjusting the transmission parameters based on the local node density Node B 540 transmits a response hello message 504 to node A 520. The response hello message 504 comprises additional information added by node B 540. Subsequently, Node A 520 extracts the additional information from the response hello message 504 and updates its statistical table with the most current communication parameters. Node A 520 then sends hello message 506 and hello message 510 to Node C 560 and Node B 540 respectively. In one embodiment, Node A 520 adds additional information in the hello messages 506 and 510 based on the most current communication parameters stored in its statistical table.

Subsequently, Node B 540 determines density of nodes in the wireless communication network based on the additional information in the hello message 510. Node B 540 also sends a response hello message 512 to Node A 510 after adjusting its communication parameters based the determined density of nodes in accordance with embodiments of the invention. Similarly, the local density of nodes can be determined at node C 560 by reception of hello message 506 from node A 520 and hello message 514 from node B 540. Node C 560 sends hello messages 508 and 516 in response to the hello messages received from node A 520 and node B 540 respectively.

Referring now to FIG. 6, a signaling diagram illustrating a method for determining density of nodes at a first node in accordance with some embodiments is shown at 600. FIG. 6 illustrates the concept of prioritizing hello messages to particular nodes in accordance with some embodiments of the invention. FIG. 6 shows three nodes: node A 620, node B 640, and node C 660. For the purpose of illustration it is assumed that there is no change in the communication parameter associated with node A 620 over a period of time. As shown in FIG. 6, node B receives a hello message 602 from node A 620 wherein the hello message comprises additional information. Node B 640 also receives a hello message 604 from node C 660 which also comprises additional information enveloped by node C 660. If based on the additional information in hello message 604, node B 640 determines that at least one of the communication parameter associated with Node C has changed then node B will prioritize transmission of response hello messages to node C. As shown in FIG. 6, in such a situation node B would send a response hello message 606 to node C prior to sending a response hello message 608 to node A.

FIG. 7 is a block diagram illustrating an apparatus 700 to determine density of nodes in the wireless communication network in accordance with some embodiments. The apparatus 700 implements the methods 200 and 300 described in FIGS. 2 and 3 in accordance with various embodiments of the present invention. The apparatus 700 can be any type of wireless communication device including, but not limited to, cellular, mobile, and wireless telephones; PCs (personal computers), laptop, notebook, and wearable computers with wireless modems, PDAs (personal digital assistants) with wireless modems; and wireless messaging devices. Apparatus 700 also illustrates functional blocks of the nodes 110, 120, 130, 140, 150 of wireless communication network 100 as shown in FIG. 1 in accordance with embodiments of the invention.

As shown in FIG. 7, apparatus 700 comprises an antenna 710, a transceiver 720, a processor 730, and a memory 740. The antenna 710 shown in FIG. 7 may be an omni-directional, sectored, MIMO (Multiple In, Multiple Out, a technology that allows antennae to process numerous incoming and outgoing signals simultaneously), or smart antenna array which is configured to transmit or receive a data to or from any local node in the wireless communication network 100. The transceiver 720 transmits/receives signals via the antenna 710. The transceiver 720 is coupled to a processor 730. The processor 730 is configured to receive messages from a second node, wherein the hello message comprises additional information indicating at least a number of hello messages received from a plurality of nodes in the wireless communication network. The processor 730 is further configured to extract the additional information from the hello message and based on the extracted information determining at least one channel performance metric. The processor 730 is also configured to determine density of nodes based on the at least one channel performance metric. FIG. 7 also shows a memory element 740 coupled to the processor 730 which can store statistical table 400, wherein the statistical table 400 comprises communication parameters for a plurality of nodes as shown in FIG. 4.

Those skilled in the art would realize that the apparatus 700 can also include other hardware units (not shown) such as an user interface including a display, keypad, loudspeaker, and/or microphone, antenna switch, duplexer, circulator, or other highly isolative means for intermittently providing information packets from the transmitter circuitry (not shown) in the transceiver 720 to the antenna 710 and from the antenna 710 to the receiver circuitry (not shown) in transceiver 720. Alternatively, the apparatus 700 can comprise a collection of appropriately interconnected units or devices, wherein each unit or device performs functions that are equivalent to the functions performed by the elements of the apparatus 700.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that various embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for determining density of nodes at a first node in a wireless communication network, the method comprising:
receiving a hello message from a second node, wherein the hello message comprises additional information indicating at least a number of hello messages received by the second node from a plurality of nodes;
extracting the additional information from the hello message;
determining at least one channel performance metric based on the additional information extracted from the hello message; and
determining the density of nodes in the wireless communication network based on the at least one channel performance metric.

2. The method of claim 1, further comprising prior to the receiving step:
transmitting hello messages periodically within the wireless communication network.

3. The method of claim 1, wherein the number of hello messages received by the second node comprises a quantity of hello messages received in a time period.

4. The method of claim 1, further comprising:
determining a routing path of a message in the wireless communication network based on the density of nodes.

5. The method of claim 1, further comprising:
determining power level of a message to the second node in the wireless communication network based on the density of nodes.

6. The method of claim 1, further comprising:
sending a response hello message to the second node.

7. The method of claim 6, wherein the response hello message to the second node is prioritized based on the at least one channel performance metric.

8. The method of claim 1, wherein the additional information comprises information indicating at least one of:
a power level used by the second node to transmit the hello message;
a frequency of transmitting hello messages from the second node; and
a modulation scheme used by the second node to transmit hello messages.

9. The method of claim 1, wherein determining at least one channel performance metric comprises forming a statistical table, wherein the statistical table comprises communication parameters of one or more received communication signals received from at least one of the plurality of nodes.

10. The method of claim 9, further comprising
comparing the communication parameters with a plurality of predefined parameters to estimate a density pattern in the wireless communication network.

11. A method for determining density of nodes in a wireless communication network, the method comprising:
transmitting hello messages from a plurality of nodes in the wireless communication network, wherein the hello messages comprise additional information;
extracting the additional information to determine at least one channel performance metric for the plurality of nodes in the wireless communication network; and
determining the density of nodes at each of the plurality of nodes based on the at least one channel performance metric.

12. The method of claim 11, wherein the additional information in a hello message from a node indicates a number of hello messages received by the node from the plurality of nodes over a time period.

13. The method of claim 12 further comprising:
selecting at the node, a subset of nodes from the plurality of nodes;
including additional information related to the subset of nodes in a second hello message; and
transmitting the second hello message to the plurality of nodes in the wireless communication network.

14. The method of claim 11, wherein determining the density of nodes at each of the plurality of nodes further comprises estimating proximity of the plurality of nodes based on the additional information.

15. The method of claim 11, wherein determining at least one channel performance metric comprises forming a statistical table, wherein the statistical table includes a plurality of entries comprising communication parameters of one or more received communication signals received from at least one of the plurality of nodes.

16. The method of claim 15, wherein the communication parameters for the plurality of nodes comprises:
a power level used for transmitting hello messages, a frequency of transmitting hello message; and
a modulation scheme used to transmit hello messages.

17. The method of claim 13, further comprising:
detecting at the node, a change in a communication parameter for at least one of the plurality of nodes;
adjusting at the node, a power level of transmission of messages to the at least one of the plurality of nodes; and
prioritizing at the node, transmission of the second hello message to the at least one of the plurality of nodes.

18. The method of claim 11, wherein determining the density of nodes at each of the plurality of nodes further comprises:
determining a probability characteristic of receiving hello messages from the plurality of nodes based on the at least one channel performance metric;
counting a number of nodes, each using similar modulation scheme and each having same probability characteristic; and
comparing the number of nodes with a predetermined threshold to determine a node density pattern in the wireless communication network.

19. An apparatus for determining density of nodes in a wireless communication network, the apparatus comprising:
a transceiver; and
a processor configured to perform the steps of:
receiving a hello message from a second node, wherein the hello message comprises additional information, indicating at least a number of hello messages received from a plurality of nodes in the wireless communication network,
extracting the additional information from the hello message,
determining at least one channel performance metric based on the additional information extracted from the hello message, and
determining the density of nodes based on the at least one channel performance metric.

20. The apparatus of claim 19, further comprising:
a memory coupled to the processor for storing a statistical table, wherein the statistical table comprises communication parameters for the plurality of nodes.
